(19) United States
(12) Patent Application Publication
(10) Pub. No.: US 2016/0177002 A1
(43) Pub. Date: Jun. 23, 2016

(54) HYDROGEL FIBERS AND PREPARATION THEREOF

(71) Applicant: INTELLISIV LTD., GEDERA (IL)

(72) Inventors: OLEG PALCHIK, GEDERA (IL); HADAS KAMINSKY, MA'ALE ADUMIM (IL); LEV KUNO, TZUR HADASSAH (IL)

(21) Appl. No.: 14/909,328

(22) PCT Filed: Jul. 31, 2014
(86) PCT No.: PCT/IL2014/050696

§ 371 Date: Feb. 1, 2016

Related U.S. Application Data
(60) Provisional application No. 61/860,992, filed on Aug. 1, 2013.

(51) Int. Cl. C08F 220/58; C09D 133/26; B29C 35/10; B29C 47/00; B29C 47/08; B29C 47/10; C08F 220/06; C09D 133/02

(52) U.S. Cl. CPC C08F 220/58; C08F 220/06; C09D 133/26; C09D 133/02; B29C 47/0088; B29C 47/0801; B29C 47/1063; B29C 35/10; B29K 2995/0068

(57) ABSTRACT

This invention provides a Polymer Fiber and Polymer Optical Fiber (POF) wherein said polymer is a hydrogel. This invention further provides a process for preparing water-absorbent and superabsorbent acrylate polymer fibers and polymer optical fibers, and provides encapsulated, biodegradable, renewable and functional hydrogel fibers and hydrogel optical fibers prepared according to the process of this invention.

### FIELD OF THE INVENTION

This invention provides a Polymer Fiber and Polymer Optical Fiber (POF) wherein said polymer is a hydrogel. This invention further provides a process for preparing water-absorbent and superabsorbent acrylate polymer fibers and polymer optical fibers, and provides encapsulated, biodegradable, renewable and functional hydrogel fibers and hydrogel optical fibers prepared according to the process of this invention.

### BACKGROUND OF THE INVENTION

Modern fibers industry is a big business and fibers could be found in a wide variety of applications. Polymer fibers constitute largest part of world fiber market and are used to prepare woven materials, non-woven materials, non-woven fabrics, such as wipers, diapers, industrial garments, medical and health garments or filtration garments.

Water-absorbent polymers or hydrogels are macromolecular networks of hydrophilic water-insoluble polymer chains, with the ability to absorb aqueous fluids by means of hydrogen bonding or hydration of the charged particles. The polymer matrix is called hydrogel if it can absorb water more than 20% of its original weight. In contact with aqueous medium the hydrogel swell to the extent, which is mainly determined by the hydrogel network crosslink density, charge of polymer, etc. Cross-links between polymer chains form a three-dimensional network and prevent the polymer swelling to infinity i.e. dissolving. The cross-links can be formed by covalent bonds, or electrostatic, hydrophobic, or dipole-dipole interactions. This is due to the elastic retraction forces of the network, and is accompanied by a decrease in entropy of the chains, as they become stiffer from their originally coiled state. The hydrophilicity is due to the presence of hydrophilic groups, such as hydroxyl, carboxyl, amide, and sulfonic groups along the polymer chain.

Superabsorbent is a hydrogel that is very lightly cross linked and can absorb and retain huge quantities of water (up to 500 times of its own weight). Early superabsorbents were made from chemically modified starch and cellulose and other polymers like poly(vinyl alcohol) PVA, poly(ethylene oxide) PEO, all of which are hydrophilic and have a high affinity for water.

In order to ensure higher rates of water swelling of the polymer matrix, it is often made of charged monomers, such as sodium acrylate which can be neutralized afterwards.

With the initial and successful use of hydrogels in contact lenses, the hydrogel applications are widespread.

Hydrogels are currently used as scaffolds in tissue engineering, where they may contain cells to repair defective tissue. Environmentally sensitive hydrogels can sense the changes in pH, temperature or the concentration of metabolite, so they can release their load as a result of such changes. Hydrogels that are responsive to specific molecules (e.g. glucose or antigens) can be used as bio-sensors and as controlled-release delivery systems for bio-active agents and agrochemicals.

Most of the known hydrogel and absorbent fibers are made of hydrophilic synthetic monomers (e.g. acryl amide, acrylonitrile) and modified natural polymer networks (e.g. cellulose). Hydrogel fibers (including superabsorbent fibers) are made by the solvent or solution polymerization method.

Optical fibers are expected to be insensitive to environmental effects in order to ensure non-disturbed wave-guiding of light signals for communication purposes. Generally optical fibers have two protective coatings, cladding and jacket, in order to make them insensitive to the environment. Due to their water absorption, hydrogels are highly sensitive to temperature, pressure and pH. Because of their high sensitivity to environmental effects, hydrogel based optical fibers could be used as highly sensitive detectors, for sensing specific disturbances in an optical signal.

Normally, hydrogels prepared by regular processes, have rather high scattering due to the lack of homogeneity, which result in milky appearance of the hydrogel. Regular processes for preparation of hydrogel fibers require multiple steps and the obtained fibers are further treated in different ways in order to have swelling ability. Such processes are expected to result in non homogeneous fibers which are less likely to be useful as optical fibers.

Increasing environmental concerns and ongoing legislation to cut the emissions of volatile organic compounds (VOCs) have been the major driving force behind the development of radiation curing coatings over the past 30 years. Radiation curing, including ultraviolet (UV-curing) and electron beam (EB) curing technology, is now being increasingly used in various applications due to the clean and green technology that increases productivity as compared with other traditional methods of curing. This technology is now commonly utilized to perform fast drying of protective coatings, varnishes, printing inks, and adhesives, and to produce the high definition images required in the manufacture of microcircuits and printing plates. Thus, radiation curing can be used for polymerization providing a fast chemical reaction, spatial resolution, ambient temperature operation, solvent-free formulations and low energy consumption.

Ultraviolet cured inks, coatings, adhesives, silicones and specially coatings provide outstanding physical and chemical properties which are paramount in the success of most applications. Ultraviolet curing has been employed successfully for over ten years in the flexographic printing industry, as it offers outstanding print quality compared to solvent or water-based ink systems.

One of the applications of UV curing technology which is related to fibers is a UV coating of optical glass fibers. Generally two-layer UV coating applied on such fibers: inner soft coating and outside hard coating. Frequently such coatings are colored, in order to distinguish different types of glass fibers. Despite coloration, UV coating lines have enormous production, allowing two-stage coating of glass at high speeds, typically about 35 m/sec (2100 m/min).

U.S. Pat. No. 3,940,542 describes a method of producing hydrogel fibers based on polyurethane chemistry. The process described is a two-step process. First polyurethane prepolymer is produced using benzene as a solvent, followed by the production of a fiber using wet-spinning method into benzene-hexane bath. In this patent solvents are used extensively.

U.S. Pat. No. 4,873,143 describes a method of production of hydrogel fibers from modified acrylonitrile (AN) fiber. According to U.S. Pat. No. 4,873,143 AN fiber is boiled in 30% acoustic soda solution for 10 minutes, following by neutralization of the fiber containing acoustic soda solution with sulfuric acid.

U.S. Pat. No. 5,582,786 and U.S. Pat. No. 6,436,323 describe a method of producing water-absorbent (hydrogel) fiber from preformed acrylic polymer 38% aqueous solution using a two-step process comprising synthesis of polymer, following by fiber spinning. Fiber spinning is done in dry-spinning mode, which requires intense heating in order to evaporate all water and subsequently perform crosslinking of the polymer.

This invention is directed to the preparation of water absorbing polymer fibers and nanofibers by radiation, specifically using ultraviolet and visual radiation. This invention is further directed to hydrogel optical fibers prepared according to the process of this invention, which could have high homogeneity and transparency.

### SUMMARY OF THE INVENTION

In one embodiment, this invention is directed to a polymer optical fiber (POF), wherein said polymer is an aqueous-solution absorbing polymer. In another embodiment, the fiber is crosslinked less than about 4% mole crosslinking density. In another embodiment, the aqueous-solution absorbing polymer has a water uptake of up to 250% w/w.

In one embodiment, this invention is directed to a polymer fiber, wherein said polymer is an aqueous-solution absorbing polymer. In another embodiment, the fiber is crosslinked less than about 4% mole crosslinking density. In another embodiment, the aqueous-solution absorbing polymer has a water uptake of up to 2000% w/w.

In another embodiment, the fiber is crosslinked less than about 4% mole crosslinking density.

In one embodiment, this invention is directed to a method of preparing an aqueous solution-absorbing polymer fiber comprising the following steps:
(i) providing a monomeric or oligomeric mixture, wherein said monomeric or oligomeric mixture comprise hydrophilic monomers or oligomers, which polymerize by radiation;
(ii) optional heating or cooling said monomeric or oligomeric mixture, for obtaining optimal viscosity;
(iii) continuously pumping said monomeric or oligomeric mixture through a spinneret die or any other nozzle arrangement; and
(iv) continuously radiating said monomeric or oligomeric mixture with a radiation source, wherein said aqueous solution-absorbing polymer fiber is formed.

In one embodiment, this invention is directed to a method of preparing an aqueous solution-absorbing polymer optical fiber (POF) comprising the following steps:
(i) providing a monomeric or oligomeric mixture, wherein said monomeric or oligomeric mixture comprise hydrophilic monomers or oligomers, which polymerize by radiation;
(ii) optional heating or cooling said monomeric or oligomeric mixture, for obtaining optimal viscosity;
(iii) continuously pumping said monomeric or oligomeric mixture through a spinneret die or any other nozzle arrangement; and
(iv) continuously radiating said monomeric or oligomeric mixture with a radiation source wherein said polymer optical fiber is formed; and
wherein said polymer is an aqueous solution-absorbing polymer.

In another embodiment, the method is solvent free. In another embodiment, the monomeric or oligomeric mixture does not comprise charged monomers or oligomers. In another embodiment, the monomeric or oligomeric mixture comprises charged monomers or oligomers. In another embodiment, the monomeric or oligomeric mixture further comprises a solvent. In another embodiment, the solvent is water. In another embodiment, the solvent is at an amount of up to 20% w/w of the mixture. In another embodiment, the solvent is at an amount of up to 5% w/w of the mixture. In another embodiment, the aqueous-solution absorbing polymer fiber has a water uptake of up to 2000% w/w. In another embodiment, the aqueous-solution absorbing polymer optical fiber (POF) has a water uptake of up to 250% w/w. In another embodiment, the polymer is a thermoset polymer.

In another embodiment, this invention is directed to a polymer optical fiber (POF), prepared according to the methods of this invention.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 depicts a schematic description for the production of aqueous solution-absorbing polymer fibers using UV curing technology.

FIG. 2 depicts an optical microscope image of the dry hydrogel fibers, prepared according to Example 1 (Experiment No. 1). Dry fiber diameter according to this figure is 512 micron.

FIG. 3 depicts an optical microscope image of the hydrogel fiber, prepared according to Example 1 (Experiment No. 1), after water swelling by the fiber. Fiber diameter after swelling according to this figure is 649 micron.

FIG. 4 depicts the water absorption capacity of fibers of this invention at 3 different temperatures, specific for body fluid applications.

FIG. 5 depicts a SEM picture of fiber cross section, which is homogenous in the core of the fiber. Such a fiber is used as an optical fiber.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

This invention is directed to aqueous solution-absorbent polymer fibers, which in one embodiment are hydrogel optical fibers. In another embodiment, the core of the polymer optical fiber comprises a hydrogel. In another embodiment, the core of the polymer optical fiber consists essentially of a hydrogel. This invention is further directed to a new, solvent free, environmentally friendly and fast method of producing such fibers. In another embodiment, this method comprises use of small amount of solvent, which in one embodiment, is water. In another embodiment, the solvent is added in an amount of about 20% w/w of the reaction mixture; in another embodiment, in an amount of about 5% w/w.

In one embodiment, this invention is directed to a method of preparing an aqueous solution-absorbing polymer optical fiber (POF) comprising the following steps:
(i) providing a monomeric or oligomeric mixture, wherein said monomeric or oligomeric mixture comprise hydrophilic monomers or oligomers, which polymerize by radiation;
(ii) optional heating or cooling said monomeric or oligomeric mixture, for obtaining optimal viscosity;
(iii) continuously pumping said monomeric or oligomeric mixture through a spinneret die or any nozzle arrangement; and
(iv) continuously radiating said monomeric or oligomeric mixture with a radiation source, wherein said polymer optical fiber is formed, and
wherein said polymer is an aqueous-solution absorbing polymer.

In another embodiment, the radiation step for the preparation of the POF is done at room temperature. In another embodiment, the radiation step is done at low temperature (10-20 deg C.). In another embodiment, the radiation step is done at elevated temperature (30-60 deg C.). In another embodiment, the polymer optical fibers have a water uptake (WU) of up to 250% w/w. In another embodiment, said hydrophilic monomers or oligomers are not charged. In another embodiment, the method is solvent free.

In one embodiment, this invention is directed to a method of preparing an aqueous solution-absorbing polymer fiber comprising the following steps:
(i) providing a monomeric or oligomeric mixture, wherein said monomeric or oligomeric mixture comprise hydrophilic monomers or oligomers, which polymerize by radiation;
(ii) optional heating or cooling said monomeric or oligomeric mixture, for obtaining optimal viscosity;
(iii) continuously pumping said monomeric or oligomeric mixture through a spinneret die or any nozzle arrangement; and
(iv) continuously radiating said monomeric or oligomeric mixture with a radiation source, wherein said aqueous solution-absorbing polymer fibers are formed.

In another embodiment, the radiation step for the preparation of the aqueous solution-absorbing polymer fiber is done at room temperature. In another embodiment, the radiation step is done at low temperature (10-20 deg C.). In another embodiment, the radiation step is done at elevated temperature (30-60 deg C.). In another embodiment, the polymer fibers have a water uptake (WU) of up to 2000% w/w. In another embodiment, said monomeric or oligomeric mixture comprise charged monomers.

Preferably, the methods described herein are solvent free. Solvent free methods are especially preferred for the preparation of hydrogel POFs, and when the monomeric/oligomeric mixtures do not include charged monomers/oligomers. Such POFs, usually have a water uptake (WU) which is not higher than 250% w/w.

In another embodiment, for preparation of hydrogel fibers with larger water uptake (WU), and which are no longer POFs, use of some amount of charged monomers/oligomers (e.g. sodium acrylate) is needed. The amount of charged monomers/oligomers needed is in some embodiments between about 10% and about 80% w/w; more preferably between about 30% and about 60% w/w; most preferably between about 40% and about 55% w/w. In another embodiment, the charged monomers or oligomers are at an amount of about 40% w/w. In another embodiment, the charged monomers or oligomers are at an amount of about 55% w/w. When charged monomers or oligomers are used, a small amount of polar solvent is necessary to solubilize the charged compounds (e.g. sodium acrylate). Accordingly, in one embodiment, the methods described herein for the preparation of hydrogel fibers, further comprise a step of adding small amount of solvent to the mixture after step (i). In another embodiment, the solvent is added to the mixture in an amount of about 50% w/w. In another embodiment, the solvent is added to the mixture in an amount of about 20% w/w. In another embodiment, the solvent is added to the mixture in an amount of about 5% w/w. In another embodiment, the solvent is added to the mixture in an amount of about 3% w/w. In another embodiment, the solvent is added to the mixture in an amount of about 1% w/w. In another embodiment, the solvent is added to the mixture in an amount of between about 3% and about 20% w/w. In another embodiment, the method does not involve the use of an organic solvent.

In another embodiment, the methods described herein involve the use of a polar solvent. In another embodiment, the solvent is a protic polar solvent. Non limiting examples of protic polar solvents include: water, n-butanol, isopropanol, n-propanol, ethanol, methanol, acetic acid, nitromethane and formic acid. In another embodiment, the methods described herein involve the use of an aprotic polar solvent. Non limiting examples of aprotic polar solvents include: dichloromethane (DCM), tetrahydrofuran (THF), ethyl acetate, acetone, dimethylformamide (DMF), acetonitrile (MeCN), Dimethyl sulfoxide (DMSO), and propylene carbonate. In another embodiment, the solvent is water.

In one embodiment, this invention is directed to a method for the production of hydrogel polymer optical fibers (POFs) comprising of the following steps:
(i) providing monofunctional and multifunctional monomers or oligomers, which are soluble in one another;
(ii) mixing the monofunctional monomer or oligomers and multifunctional monomer or oligomers, in the absence of a solvent, to form a solvent free solution;
(iii) pumping said monofunctional and multifunctional monomers or oligomers through a spinneret die or any nozzle arrangement;
(iv) exposing the solution to a source of energy, that will initiate free radical polymerization thereby creating a cross-linked hydrogel polymer optical fibers.

In another embodiment, the method for the production of hydrogel POF further comprises a step of adding small amounts of solvent, in order to completely solubilize monomers or oligomers, after step (ii). In another embodiment, said monomers or oligomers do not comprise charged monomers or oligomers.

In another embodiment, this invention is directed to a method for the production of hydrogel fibers comprising of the following steps:
(i) providing monofunctional and multifunctional monomers or oligomers, which are partially soluble in one another;
(ii) mixing the monofunctional monomer or oligomers and multifunctional monomer or oligomers, in the absence of a solvent, to form a solvent free solution; and adding small amounts of solvent, in order to completely solubilize monomers or oligomers;
(iii) pumping said monofunctional and multifunctional monomers or oligomers through a spinneret die or any nozzle arrangement;
(iv) exposing the solution to a source of energy, that will initiate free radical polymerization thereby creating a cross-linked polymer.

In another embodiment, said monomers or oligomers used for the preparation of the hydrogel fibers comprise charged monomers or oligomers. In another embodiment, the charged monomers or oligomers are at an amount of between about 5% and about 80% w/w. In another embodiment, the charged monomers or oligomers are at an amount of between about 20% and about 70% w/w. In another embodiment, the charged monomers or oligomers are at an amount of between about 30% and about 60% w/w. In another embodiment, the charged monomers or oligomers are at an amount of between about 40% and about 55% w/w. In another embodiment, the charged monomers or oligomers are at an amount of about 40% w/w. In another embodiment, the charged monomers or oligomers are at an amount of about 55% w/w.

In another embodiment, the amount of solvent added to the mixture is between about 1% and 50% w/w. In another embodiment, the amount of solvent added to the mixture is between about 3% and 20% w/w. In another embodiment, the amount of solvent added to the mixture is between about 3% and 10% w/w. In another embodiment, the amount of solvent added to the mixture is between about 5% and 10% w/w. In another embodiment, the amount of solvent added to the mixture is between about 3% and 5% w/w. In another embodiment, the amount of solvent added to the mixture is about 50% w/w. In another embodiment, the amount of solvent added to the mixture is about 20% w/w. In another embodiment, the amount of solvent added to the mixture is about 10% w/w. In another embodiment, the amount of solvent added to the mixture is about 5% w/w. In another embodiment, the amount of solvent added to the mixture is about 3% w/w. In another embodiment, the amount of solvent added to the mixture is about 1% w/w. In another embodiment, the solvent is a polar solvent. In another embodiment, the solvent is a protic polar solvent. In another embodiment, the solvent is an aprotic polar solvent. In another embodiment, the method does not involve the use of an organic solvent. In another embodiment, the solvent is water.

In another embodiment, the hydrogel fibers are polymer optical fibers (POF). In another embodiment, the core of the polymer optical fiber comprises a hydrogel. In another embodiment, the core of the polymer optical fiber consists essentially of a hydrogel.

Herein, the term “solvent” refers to a substance, other than a monomer or oligomer, which is capable of dissolving one or more monomers or oligomers. The term solvent as defined herein, includes a diluting agent.

The term “solvent free” solution refers to a solution without a solvent, as defined above.

The phrase “small amount of solvent” refers to an amount of solvent that is smaller than the overall amount of components in the mixture, i.e., up to an amount of 50% w/w; preferably, up to an amount of 20% w/w; most preferably, up to an amount of 5% w/w.

The phrase “monofunctional monomer or oligomer” refers to a monomer or an oligomer that contains only one unsaturated carbon-carbon bond that can participate in free radical polymerization. Non-limiting examples of monofunctional monomer or oligomer are acrylic acid, sodium acrylate, acryloyl morpholine, hydroxyethyl acrylate and the like.

The term “multifunctional monomer or oligomer” refers to a monomer or an oligomer that contains two or more unsaturated carbon-carbon bonds that can participate in free radical polymerization. Non-limiting examples for multifunctional monomer or oligomer are triethylene glycol divinyl ether, ethoxylated trimethylolpropane triacrylate, polyethylene glycol diacrylate, aliphatic urethane triacrylate, and the like.

The term “soluble” refers to the condition in which a first material is dissolved in a second material such that a solution is formed. As used herein, the first material is soluble in the second material if the first material readily dissolves in the second material without excessive use of heat, pressure or physical agitation.

The term “polymer optical fiber (POF)” refers to an optical fiber which is made out of a polymeric material, or plastic material. POF organic polymers are used as the fiber core. In one embodiment, the core of the polymer optical fiber according to this invention comprises a hydrogel. In another embodiment, the core of the polymer optical fiber according to this invention consists essentially of a hydrogel. In another embodiment, the cladding of the POF according to this invention comprises a hydrogel. In another embodiment, the cladding of the POF according to this invention consists essentially of a hydrogel. In another embodiment, the POF according to this invention does not have a cladding layer.

The terms “aqueous solution-absorbing”, “water-absorbing”, “water-swelling” or “hydrogel” are used interchangeably, and refer to compounds that can absorb and retain large amounts of aqueous solution or water relative to their own mass. In another embodiment, the hydrogel POF according to this invention does not contain a cladding layer. Aqueous solution-absorbing polymers, and water absorbing polymers, which are classified as hydrogels when cross-linked, absorb aqueous solutions through hydrogen bonding with water molecules. The water uptake of hydrogel polymer fibers according to this invention can be up to 2000% w/w. The water uptake of hydrogel fibers which are POFs can be up to 250% w/w.

The term “room temperature” refers to a temperature inside a temperature-controlled building, which is a temperature in the range of 20° C. (68° F. or 293 K) to 25° C. (77° F. or 298 K).

In another embodiment, the aqueous solution-absorbing polymer fiber of this invention is water-absorbing polymer fiber. In another embodiment, the aqueous solution-absorbing polymer fiber of this invention is a hydrogel fiber. In another embodiment, the fiber of this invention is an optical fiber. In another embodiment, the fiber of this invention is a polymer optical fiber (POF). In another embodiment, the water-absorbent polymer is a water-superabsorbent polymer (SAP). In another embodiment, the radiation source is ultraviolet (UV) light.

In one embodiment, this invention is directed to a method of making superabsorbing polymer fibers (hydrogel fibers) by mixing one or more monofunctional monomers or oligomers with one or more multifunctional monomers or oligomers in the absence of a solvent to form a solvent free solution.

In another embodiment, small amount of solvent can be further added to the solvent free mixtures, in order to completely solubilize monomers or oligomers. In another embodiment, the amount of solvent added to the mixture is between about 1% and 50% w/w. In another embodiment, the amount of solvent added to the mixture is between about 3% and 20% w/w. In another embodiment, the amount of solvent added to the mixture is between about 3% and 10% w/w. In another embodiment, the amount of solvent added to the mixture is between about 5% and 10% w/w. In another embodiment, the amount of solvent added to the mixture is between about 3% and 5% w/w. In another embodiment, the amount of solvent added to the mixture is about 50% w/w. In another embodiment, the amount of solvent added to the mixture is about 20% w/w. In another embodiment, the amount of solvent added to the mixture is about 10% w/w. In another embodiment, the amount of solvent added to the mixture is about 5% w/w. In another embodiment, the amount of solvent added to the mixture is about 3% w/w. In another embodiment, the amount of solvent added to the mixture is about 1% w/w. In another embodiment, the solvent is polar solvent. In another embodiment, the solvent is an aprotic polar solvent. In another embodiment, the solvent is a protic polar solvent. In another embodiment, the method does not involve the use of an organic solvent. In another embodiment, the solvent is water. At least one multifunctional monomer or oligomer must be present in the formulation. In another embodiment, all monomers or oligomers in the mixture are multifunctional. Charged monofunctional or multifunctional monomers or oligomers may be present in the mixture, in an amount of 30%, 35%, 40%, 45%, 50%, 55%, 60%, 65% or 70% w/w.

To facilitate the polymerization process, a free radical initiator is optionally added to the mixture of monomers or oligomers, prior to exposing the mixture to the source of energy. The monofunctional monomers or oligomers, the multifunctional monomers or oligomers and photoinitiators (free radical initiator) are selected so that they are soluble in one another. In another embodiment, small amount of solvent is added in case the monofunctional monomers or oligomers and the multifunctional monomers or oligomers are only partially soluble in one another. In another embodiment, oxygen is optionally removed from the solution prior to fiber production using known degassing methods. A typical source of energy that can be used to initiate the free radical polymerization is ultraviolet (UV) light. In another embodiment, the method of making aqueous solution-superabsorbing polymer fibers (hydrogel fibers) according to this invention result in the formation of homogenous and transparent fibers. In another embodiment, the method results in the formation of hydrogel polymer optical fibers (POF).

In one embodiment, the properties of the polymer fibers of this invention are determined by the monomers, oligomers, viscosity of the composition mixture and the crosslinking density in the fibers.

In one embodiment, the monomeric or oligomeric mixture includes monofunctional monomers or oligomers, multifunctional monomers or oligomers, or combination thereof.

In one embodiment, a cross-linked network is formed as a solid fiber that will readily absorb aqueous solutions. The fibers that are formed can be left intact or ground for use as a powder. The absorption capability of the polymer thus formed depends on the chemistry of the monomers or oligomers used and the molar ratios or weight ratio of monofunctional monomer or oligomer to multifunctional monomer or oligomer (crosslinking ratio). Furthermore, the process can be adjusted by varying the amount of initiator, the intensity and/or length of time the solution is exposed to the source of energy and/or the amount of oxygen in the solution.

The diameter of the fibers described in this invention could be influence by many parameters, such as spinneret/die hole size, viscosity of formulations and parameters which are known to one skilled in the art.

In one embodiment, the typical diameter of a dry fiber according to this invention (before water swelling) is 500 μm. In another embodiment, the diameter is 512 μm. In another embodiment, the diameter is between about 30 μm and about 1000 μm. In another embodiment, the diameter is between about 300 μm and about 700 μm. In another embodiment, the diameter is between about 300 μm and about 400 μm. In another embodiment, the diameter is between about 400 μm and about 500 μm. In another embodiment, the diameter is between about 500 μm and about 600 μm. In another embodiment, the diameter is between about 400 μm and about 600 μm. In another embodiment, the diameter is between about 300 μm and about 600 μm. In another embodiment, the diameter is between about 400 μm and about 700 μm. In another embodiment, the diameter is about 300 μm. In another embodiment, the diameter is about 350 μm. In another embodiment, the diameter is about 400 μm. In another embodiment, the diameter is about 450 μm. In another embodiment, the diameter is about 500 μm. In another embodiment, the diameter is about 550 μm. In another embodiment, the diameter is about 600 μm. In another embodiment, the fiber is a POF.

In one embodiment, the typical diameter of a hydrogel fiber according to this invention after swelling is 650 μm. In another embodiment, the diameter of a hydrogel fiber after swelling is 649 μm. In another embodiment, the diameter after swelling is between about 50 μm and about 2000 μm. In another embodiment, the diameter after swelling is between about 400 μm and about 1000 μm. In another embodiment, the diameter after swelling is between about 400 μm and about 600 μm. In another embodiment, the diameter after swelling is between about 600 μm and about 800 μm. In another embodiment, the diameter after swelling is between about 800 μm and about 1000 μm. In another embodiment, the diameter after swelling is between about 600 μm and about 2000 μm. In another embodiment, the diameter after swelling is between about 1000 μm and about 2000 μm. In another embodiment, the diameter after swelling is between about 500 μm and about 700 μm. In another embodiment, the diameter after swelling is about 400 μm. In another embodiment, the diameter after swelling is about 500 μm. In another embodiment, the diameter after swelling is about 600 μm. In another embodiment, the diameter after swelling is about 650 μm. In another embodiment, the diameter after swelling is about 700 μm. In another embodiment, the diameter after swelling is about 750 μm. In another embodiment, the diameter after swelling is about 800 μm. In another embodiment, the diameter after swelling is about 1000 μm. In another embodiment, the diameter after swelling is about 2000 μm. In another embodiment, the fiber is a POF.

In one embodiment, depending on the amount of water added to the fiber, the diameter of a typical fiber according to this invention is increased during water swelling by up to 10% of its value. In another embodiment, the diameter is increased by up to 20%. In another embodiment, the diameter is increased by up to 40%. In another embodiment, the diameter is increased by up to 60%. In another embodiment, the diameter is increased by up to 80%. In another embodiment, the diameter is increased by up to 100%. In another embodiment, the diameter is increased by up to 120%. In another embodiment, the diameter is increased by up to 140%. In another embodiment, the diameter is increased by up to 200%. In another embodiment, the diameter is increased by up to 400%. In another embodiment, the diameter is increased by up to 1000%. In another embodiment, the fiber is a POF.

The term “superabsorbent polymer” (SAP) refers to polymers that can absorb and retain extremely large amounts of a liquid relative to their own mass. The term also refers to a cross-linked polymer that is capable of readily absorbing at least 50% of its own weight in water. A SAP's ability to absorb water is a factor of the ionic concentration of the aqueous solution. In deionized and distilled water, a SAP may absorb 500 times its weight (from 30-60 times its own volume) and can become up to 99.9% liquid, but when put into a 0.9% saline solution, the absorbency drops to maybe 50 times its weight. The total absorbency and swelling capacity are controlled by the type and degree of cross-linkers used to make the gel. Low density cross-linked SAP generally have a higher absorbent capacity and swell to a larger degree. High cross-link density polymers exhibit lower absorbent capacity and swell, but the gel strength is firmer and can maintain fiber shape even under modest pressure.

The term “water absorption capacity” refers to the amount of water that the hydrogel absorb in 10 minutes, and is represented by the following equation:

$$W U = \frac{{W}_{t} - W 0}{ WO} \cdot 100 \%$$

wherein
WU—water absorption capacity (i.e. water uptake),
Wₒ—weight of the dry hydrogel fiber.
Wₜ—weight of the swelled hydrogel fiber.

The optimal water uptake of such hydrogel optical fibers is at least 10% and no more than 500% of the fiber weight at room temperature. Higher water uptake is possible, however it results in substantial decrease in the refractive index and accordingly, in light escape from the fiber (the refractive index of water is 1.33; and of hydrogel fiber of the invention it is between about 1.45 and 1.59).

In one embodiment, the water absorption capacity of hydrogel fibers according to this invention is between 20% and 40% of its own weight. In another embodiment, the water absorption capacity of hydrogel fibers according to this invention is between 40% and 60% of its own weight. In another embodiment, the water absorption capacity of hydrogel fibers according to this invention is between 40% and 80% of its own weight. In another embodiment, the water absorption capacity of hydrogel fibers according to this invention is between 60% and 100% of its own weight. In another embodiment, the water absorption capacity of hydrogel fibers according to this invention is between 100% and 200% of its own weight. In another embodiment, the water absorption capacity of hydrogel fibers according to this invention is between 120% and 140% of its own weight. In another embodiment, the water absorption capacity of hydrogel fibers according to this invention is between 200% and 400% of its own weight. In another embodiment, the water absorption capacity of hydrogel fibers according to this invention is between 20% and 200% of its own weight. In another embodiment, the water absorption capacity of hydrogel fibers according to this invention is between 20% and 400% of its own weight. In another embodiment, the water absorption capacity of hydrogel fibers according to this invention is between 20% and 2000% of its own weight. In another embodiment, the water absorption capacity of hydrogel fibers according to this invention is between 400% and 2000% of its own weight. In another embodiment, the water absorption capacity of hydrogel fibers according to this invention is between 1000% and 2000% of its own weight. In another embodiment, the water absorption capacity of hydrogel fibers according to this invention is 20% of its own weight. In another embodiment, the water absorption capacity of hydrogel fibers according to this invention is 40% of its own weight. In another embodiment, the water absorption capacity of hydrogel fibers according to this invention is 60%. In another embodiment, the water absorption capacity of hydrogel fibers according to this invention is 80%. In another embodiment, the water absorption capacity of hydrogel fibers according to this invention is 100%. In another embodiment, the water absorption capacity of hydrogel fibers according to this invention is 120%. In another embodiment, the water absorption capacity of hydrogel fibers according to this invention is 130%. In another embodiment, the water absorption capacity of hydrogel fibers according to this invention is 140%. In another embodiment, the water absorption capacity of hydrogel fibers according to this invention is 800%. In another embodiment, the water absorption capacity of hydrogel fibers according to this invention is 900%. In another embodiment, the water absorption capacity of hydrogel fibers according to this invention is 1000%. In another embodiment, the water absorption capacity of hydrogel fibers according to this invention is 1500%. In another embodiment, the water absorption capacity of hydrogel fibers according to this invention is 2000%. In another embodiment, the fiber is a POF. In another embodiment, the water absorption capacity of hydrogel POF according to this invention is between 20% and 250% of its own weight.

In one embodiment, the water uptake of a hydrogel polymer optical fiber according to this invention is up to 250% of the fiber weight; or in another embodiment, up to 200%; or in another embodiment, up to 150%. In another embodiment, the water uptake of hydrogel polymer optical fibers according to this invention is between about 50% and about 250%. In another embodiment, the water uptake of hydrogel polymer optical fibers according to this invention is between about 20% and about 200%. In another embodiment, the water uptake of hydrogel polymer optical fibers according to this invention is between about 95% and about 150%.

In another embodiment, the water uptake of hydrogel fibers according to this invention is between about 50% and about 2000%. In another embodiment, the water uptake of hydrogel fibers according to this invention is between about 800% and about 2000%. In another embodiment, the water uptake of hydrogel fibers according to this invention is between about 20% and about 1850%. In another embodiment, the water uptake of hydrogel fibers according to this invention is between about 100% and about 1000%. In another embodiment, the water uptake of hydrogel fibers according to this invention is at least 20%; or in another embodiment, at least 50%; in another embodiment, at least 150%; in another embodiment, at least 400%; in another embodiment, at least 800%; in another embodiment, at least 1500%.

In another embodiment, fiber which has a water uptake of up to 250%, is a hydrogel POF. In another embodiment, fiber which has a water uptake of up to 2000%, is a hydrogel fiber.

In one embodiment, the term “a” or “one” or “an” refers to at least one. In one embodiment, “about” or “approximately” may comprise a deviance from the indicated term of +1%, or in some embodiments, −1%, or in some embodiments, ±2.5%, or in some embodiments, ±5%, or in some embodiments, ±7.5%, or in some embodiments, ±10%, or in some embodiments, ±15%, or in some embodiments, ±20%, or in some embodiments, ±25%.

In one embodiment, the monomeric/oligomeric mixture used in the method of this invention includes monofunctional monomers/oligomers, multifunctional monomers/oligomers, or combination thereof

In another embodiment, the amount of monofunctional and/or multifunctional monomer or oligomer used in the method of this invention included in the uncured compositions may vary widely, and be limited according to the performance requirements of the desired fiber, and the relatively high viscosity of the monomer or oligomer. In another embodiment, the monomer or oligomer is present in the uncured compositions in an amount ranging up to about 90 wt. %, based upon the total weight of the particular composition. In another embodiment, the monomer or oligomer is present in the uncured compositions in an amount from about 10 wt. % to about 80 wt. %, based upon the total weight of the particular composition. In another embodiment, the monomer or oligomer is present in the uncured compositions in an amount from about 30 wt. % to about 70 wt. %, based upon the total weight of the particular composition. In another embodiment, the monomer or oligomer is present in the uncured compositions in an amount from about 60 wt. % to about 95 wt. %, based upon the total weight of the particular composition. In another embodiment, the monomer or oligomer is present in the uncured compositions in an amount from about 65 wt. % to about 90 wt. %, based upon the total weight of the particular composition. In another embodiment, the monomer or oligomer is present in the uncured compositions in an amount from about 40 wt. % to about 99 wt. %, based upon the total weight of the particular composition. In another embodiment, the monomer or oligomer is present in the uncured compositions in an amount from about 40 wt. % to about 60 wt. %, based upon the total weight of the particular composition. In another embodiment, the monomer or oligomer is present in the uncured compositions in an amount of 95% based upon the total weight of the particular composition.

Many different monofunctional monomers/oligomers and multifunctional monomers/oligomers can be used to customize properties of the hydrogel fiber. In one embodiment, the method of the present invention allows the use of monofunctional monomers/oligomers and multifunctional monomers/oligomers that are soluble in one another but are not both adequately soluble in a common solvent which is capable of sustaining free radical polymerization. Hence, the method of the present invention allows the combinations of monofunctional monomers/oligomers and multifunctional monomers/oligomers previously considered not feasible due to the lack of an acceptable common solvent. In another embodiment, the monofunctional and/or multifunctional monomers or oligomers are hydrophilic. In another embodiment, the hydrogel fiber prepared according to the method of the present invention is a POF. In another embodiment, the monomers/oligomers used for preparation of POFs according to this invention do not contain charge.

In one embodiment, monomers or oligomers useful in the inventive compositions include those containing at least one ethylenically unsaturated group, meth(acrylate) group, vinyl ether group, epoxy group, oxetane groups, or any other group suitable for UV polymerization. Non limiting examples of monomers which comprise ethylenically unsaturated groups include 2-hydroxy ethyl acrylamide (HEAAm), acrylic acid or salts thereof (e.g. sodium acrylate), (meth)acrylate, styrene, vinylether, vinyl ester, N-substituted acrylamide, N-vinyl amide, maleate ester, and fumarate ester. Other functionalities contemplated by the present invention that permit polymerization upon exposure to radiation include epoxy groups, oxetane groups, as well as thiol-ene and amine-ene systems. In another embodiment, the monomers or oligomers comprise 2-hydroxy ethyl acrylamide (HEAAm). In another embodiment, the monomers or oligomers comprise acrylic acid or salts thereof. In another embodiment, the monomers or oligomers consist essentially of 2-hydroxy ethyl acrylamide (HEAAm). In another embodiment, the monomers or oligomers consist essentially of acrylic acid or salts thereof. In another embodiment, the monomers or oligomers comprise n-hydroxyethyl acrylamide. In another embodiment, the monomers or oligomers comprise polyethylene glycol diacrylate (e.g. SR610). In another embodiment, the monomers or oligomers comprise ethoxylated trimethylolpropane triacrylate (e.g. SR415, SR9035). In another embodiment, the monomers or oligomers comprise aliphatic urethane triacrylate (e.g. CN9245). In another embodiment, the monomers or oligomers comprise acrylic acid or salt thereof. In another embodiment, the monomers or oligomers comprise sodium acrylate (NaAc). In another embodiment, the polymer fibers obtained from these monomers or oligomers are hydrogel fibers. In another embodiment, the polymer fibers obtained from these monomers or oligomers are homogeneous and transparent. In another embodiment, the polymer fibers obtained from these monomers or oligomers are optical fibers. In another embodiment, the fiber is a POF.

In another embodiment, the monomers, oligomers, monomeric mixture or oligomeric mixture of this invention comprise acrylates, acrylic esters, polyurethane acrylates, polyester acrylates, epoxy acrylates, acrylic acid, methyl methacrylate, methacrylic esters, acrylonitrile, plant oils, unsaturated fatty acid, epoxy monomers, vinyl-ethers, isobutyl vinyl ether, thiol-enes, styrene, propylene, ethylene, urethane, alkylene monomers, or any combination thereof.

Examples of monofunctional monomers/oligomers that can be used with the present invention include acrylate monomers/oligomers, methacrylate monomers/oligomers, charged monomers/oligomers and vinyl monomers/oligomers.

In one embodiment, the term “acrylate” as used throughout the present application covers both acrylate and methacrylate functionality.

Examples of acrylate monomers or oligomers include acrylic acid, 2-hydroxyethyl acryl amide (HEAAm), n-hydroxyethyl acrylamide, polyethylene glycol diacrylate, ethoxylated trimethylolpropane triacrylate, aliphatic urethane triacrylate, sodium acrylate (NaAc), 2-hydroxyethyl acrylate, 2-hydroxyethyl acrylate, acrylamide, 2-(2-ethoxyethoxy)ethyl acrylate and glycerol monoacrylate. In another embodiment, the acrylate monomer for use according to this invention is hydroxyacrylamide. In another embodiment, the acrylate monomer for use according to this invention is 2-Hydroxyethyl Acryl Amide (HEAAm). In another embodiment, the acrylate monomer for use according to this invention is n-hydroxyethyl acrylamide. In another embodiment, the acrylate monomer for use according to this invention is polyethylene glycol diacrylate (e.g. SR610). In another embodiment, the acrylate monomer for use according to this invention is ethoxylated trimethylolpropane triacrylate (e.g. SR415, SR9035). In another embodiment, the acrylate oligomer for use according to this invention is aliphatic urethane triacrylate (e.g. CN9245). In another embodiment, the acrylate monomer for use according to this invention is sodium acrylate (NaAc). In another embodiment, the acrylate monomer for use according to this invention is 2-hydroxyethyl acrylate (Acros).

Methacrylate monomers/oligomers suitable for use in this invention include methacrylic acid, 2-hydroxyethylmethacrylate, 2-ethoxyethyl methacrylate, and glycerol monomethacrylate.

Example of charged monomers/oligomers that can be used with present invention are sodium/potassium acrylate or methacrylates, acrylic acid salts (e.g. sodium or potassium, NaAc), 2-Acrylamido-2-methylpropane sulfonic acid, (3-Sulfopropyl)-acrylate-potassium or sodium salt, (3-Sulfopropyl)-methacrylate-potassium or sodium salt, Itaconicacid-bis-(3-sulfopropyl)-ester-di-potassium salt, N,N-Dimethyl-N-(2methacryloyloxyethyl)-N-(3-sulfopropyl)ammonium betaine, N,N-Dimethyl-N-(3-methacrylamidopropyl)-N-(3-sulfopropyl)ammonium betaine.

Vinyl monomers/oligomers suitable for use in this invention include vinyl acetate, vinyl sulfonic acid, vinyl methylsulfone, vinyl methylacetamide, vinyl urea, 2-vinyl pyridine, 4-vinyl pyridine and vinyl-2-pyrrolidone.

Examples of multifunctional monomers or oligomers that can be used with the present invention include pentaerythritoltriallyl ether, diethylene glycol divinyl ether, triethylene glycol divinyl ether, 1,1,1-trimethylolpropane diallyl ether, allyl sucrose, divinyl benzene, dipentaerythritolpentaacrylate, N,N′methylenebisacrylamide, triallylamine, triallyl citrate, ethyleneglycoldiacrylate, diethylene glycol diacrylate, di-ethylene glycol dimethacrylate, tetraethylene glycol diacrylate, trimethylol propane trimethacrylate, ethylene glycol dimethacrylate, tetraethylene glycol dimethacrylate, dipropylene glycol dimethacrylate, ditrymethylol propane tetracrylate, pentaerythritoltetraacrylate, pentaerythritoltriacrylate, polyethylene glycol diacrylate (e.g. SR610), ethoxylated trimethylolpropane triacrylate (e.g. SR415, SR9035), and aliphatic urethane triacrylate (e.g. CN9245).

In another embodiment, the monomer or oligomer of this invention comprises an epoxy group. Non limiting examples of epoxy groups include: epoxy-cyclohexane, phenylepoxyethane, 1,2-epoxy-4-vinylcyclohexane, glycidylacrylate, 1,2-epoxy-4-epoxyethyl-cyclohexane, diglycidylether of polyethylene-glycol, diglycidylether of bisphenol-A, and the like.

Generally, epoxy groups can react with amines, phenols, mercaptans, isocyanates or acids to form the polymer fiber of this invention. In another embodiment the epoxy group reacts with alcohols, vinyl ethers, polyols acid and other monomers suitable for cationic UV curing to form the hydrogel fiber of this invention. In another embodiment, the epoxy monomer reacts with amine to form a polymer fiber of this invention. In another embodiment, any material that could be polymerized by radical, cationic and anionic mechanisms using radiation and specifically ultraviolet radiation, are suitable for preparation fibers of this invention.

In one embodiment the monomeric mixture or the oligomeric mixture is referred herein as a composition mixture.

In one embodiment, a diluent is added to assist in lowering the viscosity of the uncured composition mixture. In another embodiment, a diluent is added to reduce the viscosity of the monomer or oligomer of the composition mixture. In another embodiment, monomers are added as a reactive diluent. In another embodiment, a solvent is added as a reactive diluent. In another embodiment, a diluent is added to improve the solubility of monomers or oligomers.

While any number of diluents may be introduced into the aqueous solution-absorbing fiber formulation, the reactive diluent is advantageously a low viscosity monomer or oligomer or mixture of monomers or oligomers having at least one radiation-curable group. In another embodiment, the reactive diluent comprises 2-hydroxy ethyl acrylamide (HEAAm). In another embodiment, the reactive diluent comprises n-hydroxyethyl acrylamide. In another embodiment, the reactive diluent comprises polyethylene glycol diacrylate (e.g. SR610). In another embodiment, the reactive diluent comprises ethoxylated trimethylolpropane triacrylate (e.g. SR415, SR9035) In another embodiment, the reactive diluent comprises aliphatic urethane triacrylate (e.g. CN9245). In another embodiment, the reactive diluent comprises sodium acrylate (NaAc). Keeping in mind the foregoing functions, reactive diluents may be present in the uncured composition mixture of this invention in an amount effective to provide the composition with a viscosity within the foregoing ranges. Typically, these diluents will be present in the compositions in amounts up to about 70 wt. %. In another embodiment, from about 5 wt. % to about 60 wt. %. In another embodiment, from about 15 wt. % to about 50 wt. %, based on the total weight of the uncured composition.

In another embodiment a diluent of this invention is a monomer/oligomer or mixture of monomers/oligomers having an acrylate or vinyl ether group and a C₄,-C₂₀ alkyl or a polyether moiety. Non limiting examples of diluents include: 2-hydroxy ethyl acrylamide (HEAAm), n-hydroxyethyl acrylamide, polyethylene glycol diacrylate, ethoxylated trimethylolpropane triacrylate, aliphatic urethane triacrylate, sodium acrylate (NaAc), hexylacrylate, 2-ethylhexylacrylate, isobomylacrylate, decylacrylate, laurylacrylate, stearylacrylate, 2-ethoxyethoxy-ethylacrylate, laurylvinylether, 2-ethylhexylvinyl ether, N-vinyl formamide, isodecyl acrylate, isooctyl acrylate, vinyl-caprolactam, N-vinylpyrrolidone, and the like, and mixtures thereof. In another embodiment, the reactive diluent comprises 2-hydroxy ethyl acrylamide (HEAAm). In another embodiment, the reactive diluent comprises n-hydroxyethyl acrylamide. In another embodiment, the reactive diluent comprises polyethylene glycol diacrylate (e.g. SR610). In another embodiment, the reactive diluent comprises ethoxylated trimethylolpropane triacrylate (e.g. SR415, SR9035). In another embodiment, the reactive diluent comprises aliphatic urethane triacrylate (e.g. CN9245). In another embodiment, the reactive diluent comprises sodium acrylate (NaAc). In another embodiment, the reactive diluent consists essentially of 2-hydroxy ethyl acrylamide (HEAAm).

Another type of reactive diluent or a monomer, that can be used in the uncured composition mixture is a monomer/oligomer having an aromatic group. Non limiting examples of reactive diluents having an aromatic group include: ethyleneglycolphenylether acrylate, polyethyleneglycolphenylether acrylate, polypropyleneglycolphenylether acrylate, and alkyl-substituted phenyl derivatives of the above monomers/oligomer, such as polyethyleneglycolnonylphenylether acrylate, and mixtures thereof.

In one embodiment, the diluent of this invention or monomers/oligomers of this invention posses an allylic unsaturated group. Non limiting examples of allylic unsaturated groups include: diallylphthalate, triallyltrimellitate, triallylcyanurate, triallylisocyanurate, diallylisophthalate, and mixtures thereof.

In another embodiment, a reactive diluent or monomers/oligomers of this invention possess an amine-ene functional group. Non limiting examples include: the adduct of trimethylolpropane, isophoronediisocyanate and di(m)ethylethanolamine; the adduct of hexanediol, isophoronediisocyanate and dipropylethanolamine; and the adduct of trimethylol propane, trimethylhexamethylenediisocyanate and di(m)ethylethanolamine; and mixtures thereof.

In one embodiment, a diluent or monomers/oligomers used for the preparation of hydrogel fiber posses only one radiation-curable group. In another embodiment, a diluent suited for the preparation of hydrogel fiber possess more than one radiation-curable group.

In another embodiment, a reactive diluent comprises a monomer/oligomer having two or more functional groups capable of polymerization (i.e. radiation-curable group). Non limiting examples of such suitable diluents or monomers/oligomers include: Cₙ, hydrocarbondioldiacrylates wherein n is an integer from 2 to 18, Cn, hydrocarbondivinylethers wherein n is an integer from 4 to 18, Cn, hydrocarbon triacrylates wherein n is an integer from 3 to 18, and the polyether analogues thereof, and the like, such as 1,6-hexanedioldiacrylate, trimethylolpropanetriacrylate, hexanedioldivinylether, triethyleneglycoldiacrylate, pentaerythritoltriacrylate, ethoxylated bisphenol-A diacrylate, and tripropyleneglycol diacrylate, and mixtures thereof.

Examples of an epoxide monomer component or diluent that may be used in an embodiment of the present invention include but not limited to a benzyl glycidyl ether, an alpha, alpha-1,4-xylyldiglycidyl ether, a bisphenol-A diglycidyl ether, cresyl glycidyl ether, an ethyleneglycol diglycidyl ether, a diethyleneglycol diglycidyl ether, a neopentylglycol diglycidyl ether, a 1,4-butanediol diglycidyl ether, a 1,4-cyclohexanedimethanol diglycidyl ether, a trimethylopropanetriol triglycidyl ether, a glycerol triglycidyl ether, a cresyl glycidyl ether, a diglycidyl phthalate, a cresol novolac epoxide, a phenol novolac epoxide, a bisphenol-A novolac epoxide, 3,4-epoxy-cyclohexylmethyl-3′,4′-epoxycyclohexanecarboxylate,bis(3,5)4-epoxy cyclohexylmethyl) adipate, limonene dioxide, 1,2-epoxydecane, epoxydodecane, 1,2,7,8-diepoxyoctane, epoxidized soybean oil, epoxidized linseed oil, epoxidized castor oil, epoxidized natural rubber, epoxidized poly(1,2-butadiene), epoxy functional silicone resins, and the like.

As mentioned previously, reactive diluents may be incorporated into the mixture primarily to counter balance the high viscosity of the monomers/oligomers. In another embodiment, the diluent of this invention lowers the viscosity of the overall composition to a level sufficient to permit the composition to be drawn into fiber using mentioned drawing equipment. Examples of suitable viscosities for the mentioned fibers compositions range from about 100 to about 300,000 centipoise at 25° C. In another embodiment, suitable viscosity for fibers of the invention rages from about 100 to about 500 cp. In another embodiment, suitable viscosity for fibers of the invention rages from about 500 to about 5000 cp. In another embodiment, suitable viscosity for fibers of the invention rages from about 5000 to about 50000 cp. In another embodiment, suitable viscosity for fibers of the invention rages from about 500 to about 2000 cp. In another embodiment, suitable viscosity for fibers of the invention rages from about 100 to about 5000 cp. In one embodiment, suitable viscosity for fibers of the invention is 130 cp. In another embodiment, suitable viscosity for fibers of the invention is 460 cp. In another embodiment, suitable viscosity for fibers of the invention is 1300 cp. In another embodiment, suitable viscosity for fibers of the invention is 25,000 cp.

In some embodiments, addition of a diluent substantially improves the solubility of monomers or oligomers. In another embodiment, such diluent is referred herein as a “non-reactive diluent”. In another embodiment, the non-reactive diluent is water. In another embodiment, excessive addition of diluent may decrease the viscosity of the mixture to below 100 cP, which is undesirable for the production of fibers. In another embodiment, a diluent is added in an amount that does not reduce the viscosity of the mixture to below 100 cP. In another embodiment, the diluent is added at an amount of up to 20% w/w. In another embodiment, the diluent is added at an amount of up to 10% w/w. In another embodiment, the diluent is added at an amount of up to 5% w/w. In another embodiment, the diluent is added at an amount of up to 3% w/w. In another embodiment, the diluent is added at an amount of up to 1% w/w.

In another embodiment, the composition mixture of this invention optionally further includes one or more free-radical initiators, such as photoinitiators. Examples of such photo-sensitive initiators include benzophenone, Irgacure® 184 and Irgacure® 819 from BASF (formerly Ciba). The photoinitiators are well known to those skilled in the art, and function to hasten the cure of the radiation-curable components in the mentioned compositions. Examples of suitable free radical-type photoinitiators include, but not limited to are the following: isobutyl benzoin ether; 2,4,6-trimethylbenzoyl, diphenylphosphine-oxide; 1-hydroxycyclohexylphenyl ketone; 2-benzyl-2-dimethylamino-1-(4-morpholinophenyl)-butan-1-one; 2,2-dimethoxy-2-phenylacetophenone; perfluorinated diphenyl titanocene; 2-methyl-1-[4-(methylthio)phenyl]-2-(4-morpholinyl)-1-propanone; 2-hydroxy-2-methyl-1-phenyl propan-1-one; 4-(2-hydroxyethoxy)phenyl-2-hydroxy-2-propyl ketone dimethoxyphenylacetophenone; 1-(4-isopropylphenyl)-2-hydroxy-2-methylpropan-1-one; 1-(4-dodecyl-phenyl)-2-hydroxy-2-methylpropan-1-one; 4-(2-hydroxyethoxy)phenyl-2-(2-hydroxy-2-propyl)-ketone; diethoxyphenyl acetophenone; a mixture of (2,6-dimethoxy benzoyl)-2,4,4 trimethylpentylphosphine-oxide and 2-hydroxy-2-methyl-1phenyl-propan-1-one; benzophenone; 1-propanone, 2-methyl-I-1-(4-(methyl thio)phenyl)-2-(4-morpholinyl); and mixtures thereof.

In another embodiment, the cationic photoinitiator is chosen from the group consisting of a diaryl- or triarylsulfonium salt; a diaryliodonium salt; a dialkylphenacylsulfonium salt; and the like. Examples of cationic photoinitiators may be found in U.S. Pat. Nos. 4,882,201; 4,941,941; 5,073,643; 5,274,148; 6,031,014; 6,632,960; and 6,863,701, all of which are incorporated herein by reference.

The photoinitiator, optionally provided, is present at levels of from about 0.1 wt. % to 10 wt. %, and advantageously from about 0.2 wt. % to about 5 wt. %, of an uncured composition mixture, based upon the weight of the composition.

In one embodiment, the polymer fiber and method of preparation thereof comprise and/or make use of monomers, oligomers, monomeric mixture, oligomeric mixture and optionally photoinitiators and solvents, a single additive or additives combination.

In one embodiment, additives are optionally incorporated into the fiber compositions in effective amounts. The term “additive” is used herein as material being added to the monomeric or oligomeric mixture of this invention. The additives are added to alter and improve basic mechanical, physical or chemical properties. Additives are also used to protect the polymer from the degrading effects of light, heat, or bacteria; to change such polymer processing properties such as melt flow; to provide product color; and to provide special characteristics such as improved surface appearance, reduced friction, and flame retardancy. Non limiting examples of additives include one or more plasticizers, photo-sensitizer, anti-statics, antimicrobials, flame retardants, pharmaceuticals colorants such as dyes, reactive-dyes, pigments, catalysts, lubricants, adhesion promoters, wetting agents, antioxidants, stabilizers and any combination thereof. The selection and use of such additives is within the skill of the art.

In one embodiment, the additives of this invention have migrating or non-migrating behavior. In another embodiment, the migration of such additives is controlled by altering chemical and physical parameters of the additive (e.g. dipole moment), but also by altering chemical and physical parameters of the fibers. Examples of fiber parameters that could influence migration parameters of migration additives include, but not limited to crosslinking density, polarity, hydrophilic/hydrophobic ratio, hydrogen bonds, and crystallinity. In another embodiment, the additives are present in the composition mixture in the pure form or have special encapsulation system prior to the introduction into the uncured composition mixture.

In one embodiment additives are reactive with the fiber ingredients. In another embodiment these additives are inert toward fiber ingredients.

In one embodiment, this invention is directed to a method of preparing a hydrogel fiber and/or a hydrogel POF comprising a step of providing a monomeric or oligomeric mixture, wherein said monomeric or oligomeric mixture comprises monomers or oligomers, which polymerize by radiation. In another embodiment, the radiation comprises heat, ultrasonic sound waves, gamma radiation, infrared rays, electron beam, microwave, ultraviolet or visible light. In another embodiment, the radiation is by ultraviolet light. In another embodiment, the radiation is by visible light.

In one embodiment, this invention is directed to a method of preparing a hydrogel fiber comprising a step of radiating said monomeric or oligomeric mixture with a radiation source, wherein hydrogel fibers are formed. In another embodiment, the radiation step is done at room temperature. In another embodiment, the radiation step is done at low temperature (10-20 deg C.). In another embodiment, the radiation step is done at elevated temperature (30-60 deg C.). In another embodiment, the monomeric or oligomeric mixture is cured by UV. In another embodiment, the fibers are optical fibers. In another embodiment, the radiation source is heat, ultra sonic sound waves, gamma radiation, infrared rays, electron beam, microwaves, ultraviolet or visible light. In another embodiment, UV curing refers to ultraviolet electromagnetic radiation and to visible electromagnetic radiation. In another embodiment, the extruded composition is polymerized by exposure to radiation source to yield the hydrogel fiber of this invention. In another embodiment, the radiation source is ultraviolet light. In another embodiment, the radiation source is a visible light.

In one embodiment, the method of preparing polymer fibers of this invention further comprises take-up steps following the radiating step of the monomeric or oligomeric mixture with a radiation source.

Spinning take-up machines incorporate all the necessary devices to take-up, to handle and to wind the fibers emerging from curing unit. The process involves winding filaments under varying amounts of tension over a male mould or mandrel. The mandrel rotates while a carriage moves horizontally, laying down fibers in the desired pattern. During winding the tension on the filaments can be carefully controlled. Filaments that are applied with high tension results in a final product with higher rigidity and strength; lower tension results in more flexibility. Optionally, additional curing stage is added after filament winding in order to preserve obtained fiber properties by winding.

Standard take-up and winding machines are optionally used for fibers described in this invention.

In one embodiment, the viscosity of the composition mixture is influenced by the temperature of the uncured composition mixture. A temperature above room temperature tends to decrease viscosity and cooling below room temperature tends to increase viscosity of the composition mixture.

In one embodiment, the method of preparing the hydrogel polymer fiber of this invention comprise a step of optional heating or cooling the monomeric or oligomeric mixture with or without additives for obtaining optimal viscosity. In another embodiment, the composition mixture with or without additives is heated to a temperature of up to 60° C. In another embodiment, the composition mixture with or without additives is kept at room temperature. In another embodiment, the composition mixture with or without additives is heated to a temperature of up to 100° C. In another embodiment, the composition mixture with or without additives is heated to a temperature of between 60° C. to 100° C. In another embodiment, the composition mixture with or without additives is heated to a temperature of between 30° C. to 60° C. In another embodiment, the composition mixture with or without additives is heated to a temperature of between 30° C. to 80° C. In another embodiment, the composition mixture with or without additives is cooled to a temperature of between −20° C. to room temperature.

In one embodiment, the method of preparing the hydrogel polymer fibers of this invention is conducted at room temperature. In another embodiment this invention is directed to a method of preparing a polymer fiber comprising a step of cooling the monomeric or oligomeric mixture with or without optional additives to temperatures above solidification point of the monomer and oligomer composition. In another embodiment, the fiber is a POF.

In one embodiment the hydrogel polymer fiber of this invention is produced under air. In another embodiment, the hydrogel polymer fiber of this invention is produced under inert atmosphere, such as nitrogen, argon, or other oxygen-free gases. In another embodiment, a hydrogel polymer optical fiber is produced under inert atmosphere, such as nitrogen, argon, or other oxygen-free gases.

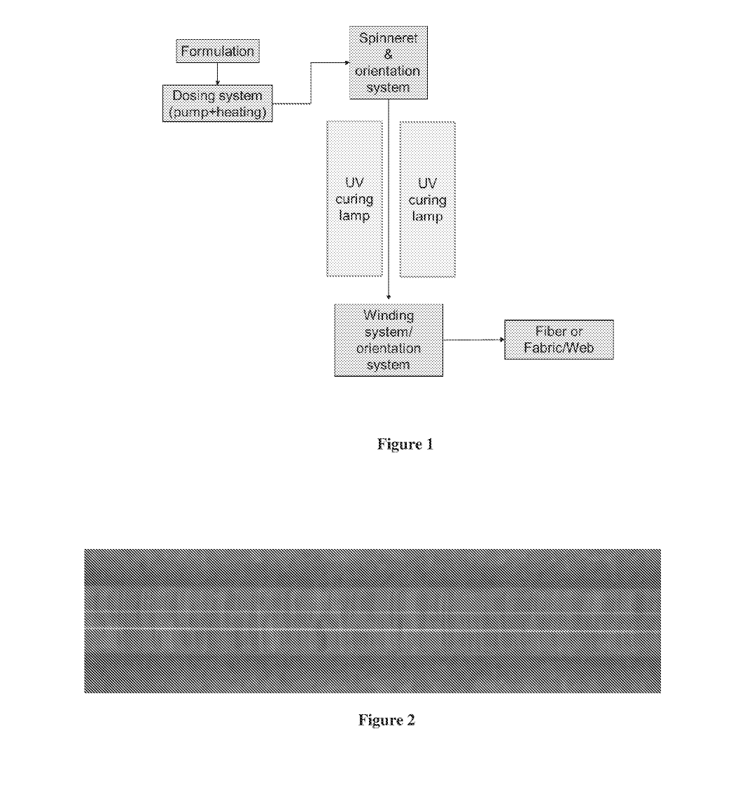

In one embodiment, this invention is directed to a method of preparing a hydrogel polymer fiber comprising a step of pumping the composition mixture through a spinneret, die or any other nozzle type. In another embodiment, the composition mixture is extruded through the spinneret, die or any other nozzle type. In another embodiment, the composition mixture is injected or pumped through the spinneret, die or any other nozzle type. Spinnerets and dies for extruding fibers are well known to those of ordinary skill in the art. As the filaments emerge from the holes in the spinneret or die, it is radiated by a radiation source to yield the polymer fiber. In another embodiment, the radiation source causes the polymerization of the monomers or oligomers. Scheme of the machine used for the fibers production is shown in FIG. 1.

In one embodiment only a single hole is present in the spinneret, die or any other nozzle type, thus only monofilament fiber could be produced. In another embodiment plurality of holes are present in the spinneret, die or any other nozzle type, thus producing numerous fibers, fabrics, bundles or any other multi-fiber arrangement.

In another embodiment, the fibers are chopped during production using a chopping machine (i.e. cutter), to obtain many short fibers.

In one embodiment the method of this invention is used for the production of nanofibers, wherein, instead of using regular spinnerets or dies, using very small die or spinnerets holes, such as used for the preparation of meltblown fibers.

In another embodiment this invention could be combined with electrospinning method of production of hydrogel nanofibers. Such combined equipment allows production of nanofibers without solvents, which are extensively used in the regular electrospinning production method. Additionally, nanofibers produced using such apparatus could be produced at ambient temperature and does not require polymer heating, thus making possible introduction of temperature-sensitive additives into the fibers.

In another embodiment, the extruded composition is polymerized into different cross-sectional shapes, such as round, hollow, layers, trilobal, pentagonal or octagonal.

The present invention can be used to create hydrogel and superabsorbent polymeric fibers, and alternate initiation methods could conceivably be employed, such as the use of an electron beam and gamma ray.

The present invention provides a method for synthesizing a hydrogel or super absorbent polymer fiber from a monofunctional monomer and a multifunctional monomer that are fully or partially soluble in one another. In another embodiment, the monofunctional monomer and multifunctional monomer do not have a common solvent. In another embodiment, the polymer fiber is a polymer optical fiber (POF).

The present invention substantially decreases, and in some embodiments, eliminates the need for an undesirable solvent as well as the need for a drying step which is typically used when producing hydrogel polymer fibers. In addition, superabsorbent polymers with physical characteristics not attainable with previously known manufacturing processes are now made possible. In another embodiment, according to the methods described herein for the preparation of hydrogel fibers, a drying step, which is typically needed when producing polymer fibers, is not required even when small amount of solvent is used.

In one embodiment, this invention is directed to an aqueous solution-absorbing polymer fiber. In another embodiment, the aqueous solution absorbing polymer fiber is a water-absorbing polymer fiber. In another embodiment, the fiber is a super absorbent. In another embodiment, the fiber is a superabsorbent acrylate polymer. In another embodiment, the fiber is a hydrogel. In another embodiment, the fiber is transparent. In another embodiment, the fiber is homogenous. In another embodiment, the fiber is an optical fiber. In another embodiment, the polymer fiber is a polymer optical fiber (POF).

In one embodiment, the hydrogel polymer optical fiber of this invention possesses an optical loss in the range of between 300-10000 dB/km. In another embodiment, the polymer optical fiber possesses an optical loss in the range of between 300-4000 dB/km. In another embodiment, the polymer optical fiber of this invention possesses an optical loss in the range of between 300-2000 dB/km. In another embodiment, the polymer optical fiber of this invention possesses an optical loss in the range of between 300-1000 db/km. In another embodiment, the polymer optical fiber of this invention possesses an optical loss in the range of between 2000-4000 dB/km. In another embodiment, the polymer optical fiber of this invention possesses an optical loss in the range of between 600-2000 dB/km.

The hydrogel polymer optical fibers prepared according to the method of this invention ensures high homogeneity of the hydrogel's polymer matrix. This feature is extremely important for optical fibers, as without homogeneity, scattering in such fibers is expected to be massive, and accordingly, optical loss will be extensive.

Hydrogel optical fibers prepared according to the subject invention have high homogeneity and are transparent.

In one embodiment, the polymer fibers of this invention are crosslinked between 0% (thermoplastics) to 99% (fully cross-linked) mole crosslinking density. In one embodiment, the polymer fiber of this invention is crosslinked less than about 99% mole crosslinking density. In another embodiment, the hydrogel polymer fiber is crosslinked less than about 75% mole crosslinking density. In another embodiment, the hydrogel polymer fiber is crosslinked in about 50%-99% mole crosslinking density. In another embodiment, the hydrogel polymer fiber is crosslinked in about 10%-50% mole crosslinking density. In another embodiment, the hydrogel polymer fiber is crosslinked in about 1%-10% mole crosslinking density. In another embodiment, the hydrogel polymer fiber is crosslinked in about 1.5%-5% mole crosslinking density. In another embodiment, the hydrogel polymer fiber is crosslinked in about 2%-20% mole crosslinking density. In another embodiment, the hydrogel polymer fiber is crosslinked in about 1.5%-50% mole crosslinking density. In another embodiment, the hydrogel polymer fiber is crosslinked in about 1.5% mole crosslinking density. In another embodiment, the hydrogel polymer fiber is crosslinked in about 2% mole crosslinking density. In another embodiment, the hydrogel polymer fiber is crosslinked in about 3% mole crosslinking density. In another embodiment, the hydrogel polymer fiber is crosslinked in about 4% mole crosslinking density. In another embodiment, the hydrogel polymer fiber is crosslinked in about 5% mole crosslinking density. In another embodiment, the hydrogel polymer fiber is crosslinked in about 6% mole crosslinking density. In another embodiment, the hydrogel polymer fiber is crosslinked in about 10% mole crosslinking density.

In another embodiment, this invention is directed to an aqueous solution-absorbing polymer optical fiber. In another embodiment, the aqueous solution is water. In another embodiment, the fiber is superabsorbent. In another embodiment, this invention is directed to an aqueous solution-adsorbing polymer fiber that encapsulates an active material. In another embodiment, this invention is directed to a biodegradable and renewable aqueous solution-absorbing polymer fiber. In another embodiment, this invention is directed to a functional aqueous solution-absorbing polymer fiber. In another embodiment, the fiber absorbs more than 20% of water based on the fiber weight. In another embodiment, the fiber is a hydrogel. In another embodiment, the fiber is an optical fiber. In another embodiment, the fiber is a polymer optical fiber (POF). In another embodiment, fiber which adsorbs up to 250% of water based on the fiber's weight, is a hydrogel POF. In another embodiment, fiber which adsorbs up to 2000% of water based on the fiber's weight, is a hydrogel fiber. In another embodiment, the fiber is a thermoset fiber.

In some embodiments, this invention is directed to a method of preparing the hydrogel polymer fiber of this invention. In one embodiment, the polymer fibers of this invention and/or method of preparation thereof comprise and/or make use of monomers, oligomers, monomeric mixture and/or oligomeric mixture, and optionally photoinitiators, diluents and/or other additives generally used on photopolymerization process. In another embodiment, the monomers or oligomers of this invention polymerize by radiation.

In another embodiment, the polymer fiber is a hydrogel fiber that encapsulates an active material. In another embodiment, the hydrogel fiber is an optical fiber. In another embodiment, the active material is a fluorescent dye. In another embodiment, the polymer fiber is a functional hydrogel fiber. In another embodiment, the polymer fiber is a biodegradable and renewable hydrogel fiber. In another embodiment, the polymer fiber is an optical fiber. In another embodiment, the fiber is a polymer optical fiber (POF).

In another embodiment, the hydrogel fiber of this invention and method of preparation thereof include the use of a crosslinking agent.

In one embodiment, this invention provides a composition mixture and methods of preparing a hydrogel fiber comprising monomers and/or oligomers which polymerize and cured by radiation, specifically by ultraviolet radiation. In another embodiment, the fiber is optical fiber. In another embodiment the monomer or oligomer of this invention comprises an ethylenic unsaturated group which polymerize via free radical polymerization. In another embodiment, the ethylenic unsaturated group is polymerized by cationic polymerization.

In one embodiment, epoxy groups polymerize through cationic polymerization, whereas the thiol-ene and amine-ene systems polymerize through radical polymerization. In another embodiment, the epoxy groups are, for example, homopolymerized. In the thiol-ene and amine-ene systems, for example, polymerization occurs between an allylic unsaturated group and a tertiary amine group or a thiol group. In another embodiment, vinylether and (meth)acrylate groups are present in the radiation-curable components of the composition mixture of this invention. In another embodiment, (meth)acrylates are present in the radiation-curable components of the composition mixture of this invention. Mixtures of mono, di-, tri-, tetra-, and higher functionalized oligomers and/or diluents can be used to achieve the desired balance of properties, wherein the functionalization refers to the number of radiation-curable groups present in the reactive component.

In another embodiment, the composition mixture could contain monomers and/or oligomers that polymerize using radical mechanism and another group of monomers and/or oligomers that polymerize using cationic mechanism. Interpenetrating Network (IPN) or Semi-IPN will be a result of the polymerization of this dual-cure system.

In another embodiment, the hydrogel fiber which is obtained by methods of this invention is coated. In another embodiment, the coating material is a thermoplastic or a thermoset polymer. In another embodiment, the process of preparing a coated hydrogel fiber includes mixing the hydrogel fiber of this invention and/or the hydrogel fiber obtained following the radiation step with a coating material following UV curing to obtain a coated hydrogel fiber. In another embodiment, the coating has hydrogel properties. In another embodiment, the coating is a hydrogel. In another embodiment, the coating step can be repeated more than once. Such coated fibers can be used as a Polymer Optical Fibers (POFs), if refractive index of the core and cladding properly selected. In another embodiment, the hydrogel fiber is not coated. In another embodiment, the hydrogel fiber is a polymer optical fiber (POF) which is not coated.

In one embodiment, this invention is directed to a method of preparing a hydrogel fiber which encapsulates an active material comprising the following steps:
(i) providing a monomeric or oligomeric mixture and an active material, wherein said monomeric or oligomeric mixture comprise hydrophilic monomers or oligomers, which polymerize by radiation;
(ii) optional heating or cooling said monomeric or oligomeric mixture, for obtaining optimal viscosity;
(iii) continuously pumping said monomeric or oligomeric mixture through a spinneret, die or any other nozzle type; and
(iv) continuously radiating said monomeric or oligomeric mixture with a radiation source, wherein said hydrogel fibers encapsulating an active material are formed.

In another embodiment, the radiation step in the preparation of the hydrogel fiber which encapsulates an active material is done at room temperature. In another embodiment, the radiation step is done at low temperature (10-20 deg C.). In another embodiment, the radiation step is done at elevated temperature (30-60 deg C.).

Preferably, the method is solvent free. In another embodiment, the method further comprises a step of adding small amount of solvent after step (i) as described herein. In another embodiment, the method does not involve the use of an organic solvent. In another embodiment, solvent is added to the mixture in an amount of about 50% w/w. In another embodiment, solvent is added to the mixture in an amount of about 20% w/w. In another embodiment, solvent is added to the mixture in an amount of about 5% w/w. In another embodiment, solvent is added to the mixture in an amount of about 3% w/w. In another embodiment, solvent is added to the mixture in an amount of about 1% w/w. In another embodiment, the solvent is water.

In another embodiment, the active material which is encapsulated in the hydrogel fiber of this invention related to any material that can encapsulate and provide a unique, specific property or activity to the hydrogel fiber. In another embodiment, the active material includes an agrochemical material (pesticides and herbicides), flame-retardant material, flavoring/essence materials, inorganic nanoparticles, dyes, pigments, phase-change materials, odor absorbing materials, a biopolymer (enzymes), living cells, soothing materials, a pharmaceuticals or any combination thereof.

The active material which is encapsulated in the hydrogel fiber of this invention related to any material that can encapsulate and provide a unique, specific property or activity to the hydrogel fiber.

In another embodiment, this invention is directed to a hydrogel fiber which encapsulates an active material and prepared according to the process of this invention. In another embodiment, the optional heating step is done at a temperature of up to 100° C.

In one embodiment, this invention is directed to a method of preparing a functional hydrogel fiber comprising the following steps:
(i) providing a monomeric or oligomeric mixture, wherein said monomeric or oligomeric mixture comprise hydrophilic monomers or oligomers, which polymerize by radiation and said hydrophilic monomers or oligomers are derivatized by a functional group;
(ii) optional heating or cooling said monomeric or oligomeric mixture, for obtaining optimal viscosity;
(iii) continuously pumping said monomeric or oligomeric mixture through a spinneret, die or any other nozzle type; and
(iv) continuously radiating said monomeric or oligomeric mixture with a radiation source, wherein said functional hydrogel fibers are formed.

In another embodiment, the radiation step in the preparation of a functional hydrogel fiber is done at room temperature. In another embodiment, the radiation step is done at low temperature (10-20 deg C.). In another embodiment, the radiation step is done at elevated temperature (30-60 deg C.).

Preferably, the method is solvent free. In another embodiment, the method does not involve the use of an organic solvent. In another embodiment, when charged monomers or oligomers are used, a small amount of polar solvent is necessary to solubilize the charged compounds (e.g. sodium acrylate). Accordingly, in another embodiment, solvent is added to the mixture in an amount of about 50% w/w. In another embodiment, solvent is added to the mixture in an amount of about 20% w/w. In another embodiment, solvent is added to the mixture in an amount of about 5% w/w. In another embodiment, solvent is added to the mixture in an amount of about 3% w/w. In another embodiment, solvent is added to the mixture in an amount of about 1% w/w. In another embodiment, the solvent is water. In another embodiment, the polymer optical fibers have a water uptake (WU) of up to 250% w/w.

In another embodiment, a functional group refers to any group which is covalently attached to the monomer or oligomer and provides the resulting hydrogel fiber a unique, specific property or activity. In another embodiment, the functional group is a fluorescent probe, an acid group, a hydroxyl group, a protein, DNA, a pharmaceutical or any combination thereof.

In another embodiment, this invention is directed to a functional hydrogel optical fiber, prepared according to the process of this invention. In another embodiment, the optional heating step is done at a temperature of up to 60° C.

In one embodiment, this invention is directed to a method of preparing a biodegradable and renewable hydrogel fiber comprising the following steps:
(i) providing a monomeric or oligomeric mixture, wherein said monomeric or oligomeric mixture comprise hydrophilic monomers or oligomers, which polymerize by radiation and said monomers or oligomers comprise an unsaturated fatty acid;
(ii) optional heating or cooling said monomeric or oligomeric mixture, for obtaining optimal viscosity;
(iii) continuously pumping said monomeric or oligomeric mixture through a spinneret or die or any other nozzle type; and
(iv) continuously radiating said monomeric or oligomeric mixture with a radiation source, wherein said biodegradable and renewable hydrogel fibers are formed.

In another embodiment, the radiation step in the preparation of the biodegradable and renewable hydrogel fiber is done at room temperature. In another embodiment, the radiation step is done at low temperature (10-20 deg C.). In another embodiment, the radiation step is done at elevated temperature (30-60 deg C.).

Preferably, the method is solvent free. In another embodiment, the method does not involve the use of an organic solvent. In another embodiment, when charged monomers or oligomers are used, a small amount of polar solvent is necessary to solubilize the charged compounds (e.g. sodium acrylate). Accordingly, in another embodiment, solvent is added to the mixture in an amount of about 50% w/w. In another embodiment, solvent is added to the mixture in an amount of about 20% w/w. In another embodiment, solvent is added to the mixture in an amount of about 5% w/w. In another embodiment, solvent is added to the mixture in an amount of about 3% w/w. In another embodiment, solvent is added to the mixture in an amount of about 1% w/w. In another embodiment, the solvent is water. In another embodiment, the polymer optical fibers have a water uptake (WU) of up to 250% w/w.

In one embodiment, a biodegradable and renewable hydrogel fiber includes monomers or oligomers which can degrade in a landfill or in a compost-like environment (i.e. biodegradable) including plant oil, or unsaturated fatty acid. In another embodiment, the monomers or oligomers are from sustainable sources such as epoxidized linseed oil, any monomer of natural origin that have ethylenical unsaturation or epoxy moiety (e.g. epoxydized fatty acids).

In another embodiment, this invention is directed to a biodegradable and renewable hydrogel fiber, prepared according to the process of this invention.

The following examples are presented in order to more fully illustrate the preferred embodiments of the invention. They should in no way be construed, however, as limiting the broad scope of the invention.

### EXAMPLES

### Example 1

### Process for the Preparation of a Hydrogel Fiber of this Invention

### Materials and Methods

2-Hydroxyethyl Acryl Amide (HEAAm), 2-Hydroxyethyl Acrylate (Acros) were supplied by TCI LTD. Acrylic acid (AA) and sodium acrylate (NaAc) were supplied by Sigma-Aldrich. SR415, SR610, SR9035, CN9245 were supplied by Sartomer. Irgacure 819 was supplied by BASF. CP4 was supplied by Miwon, Korea. All materials were used without further purification. Either distilled water or PBS (Phosphate buffer saline. 5 tablets of PBS, AMRESCO cat #E404-100TABS, lot #1532C456, dissolved in 500 ml H₂O) were used in the swelling studies.

### Monomer Preparation

HEAAm, 21 g, and SR415, 9 g were added together in to 100 ml light-blocking beaker and stirred for 10 min Irgacure 819 and CP4 were added to the mixture in 5 min interval, respectively and stirred for additional 20 min Afterwards, the mixture was allowed to reach room temperature.

For the preparation of other hydrogel fibers, the following monomer compositions were prepared according to the procedure described above:

TABLE 1
Compositions of monomers for preparation of hydrogel fibers

| Exp. | HEAAm | SR415 | SR610 | SR9035 | | | Optical loss | |
|---|---|---|---|---|---|---|---|---|
| No. | (%) | (%) | (%) | (%) | % polymerization | WU (%) | [dB/km]*** | |
| 1 | 70 | 30 | — | — | 93 | 122* | 300 | 1100 |
| 2 | 90 | 10 | — | — | 73 | 197* | 2000 | 4000 |
| 3 | 70 | — | 30 | — | 83 | 143** | 1000 | 2000 |
| 4 | 66.7 | — | — | 33.3 | 83 | 98* | 600 | 1700 |

*WU (Water Uptake) after 10 min in water at 37° C.
**WU after 10 min in water at 23° C.
***Optical loss range

TABLE 2
Compositions of monomers for preparation of
hydrogel fibers using water as a co-solvent

| Exp. | HEAAm | SR415 | | Water | % | WU |
|---|---|---|---|---|---|---|
| No. | (%) | (%) | NaAc | % | polymerization | (%) |
| 5 | 30 | 25 | 40 | 5 | >95 | 860 |
| 6 | 30 | 10 | 55 | 5 | >95 | 1850 |

**WU after 10 min in water at 23° C.

### Hydrogel Fiber Preparation:

Each of the compositions described above was added to a batcher with a spinneret at room temperature. Each one of the composition mixtures was extruded through the spinneret, and immediately irradiated with UV lamps [One 10 inch 6000 W Fusion D-lamp was arranged vertically, just below the spinneret]. Due to the presence of UV radiation, immediate polymerization of the reaction mixture occurred, thus forming solid fiber. Fibers were winded using pickup winder [two-head winder at 250 m/min speed].

An optical microscope image of the fiber obtained from composition of Exp. No. 1 is shown at FIG. 2.

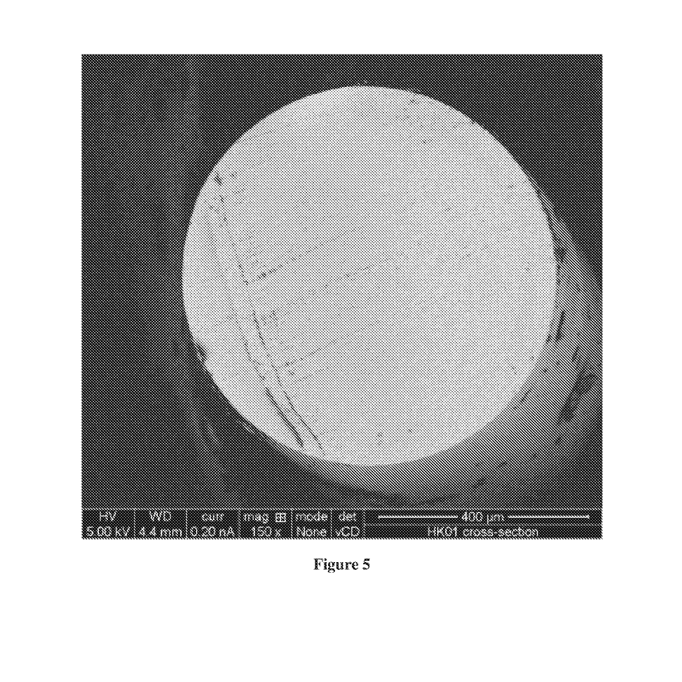

A SEM picture of a cross section of a typical fiber prepared according to this procedure is shown at FIG. 5.

### Measures and Measurement Devices

### Swelling Experiments:

In order to determine the swelling behavior of the hydrogels described above, the weight of the dry hydrogel fiber was recorded and the fiber was placed in sealed beaker containing distilled water for 10 min at different temperature (in general, in order to characterize the fiber, swelling experiments were performed for 10 minutes at 37° C.). Then the swelled fiber was drawn from the water, carefully wiped with filtration paper and the weight of a swelled fiber was recorded. The water uptake (WU) was calculated using the following equation:

$$WU = \frac{Wt - W 0}{W 0} \cdot 100 \%$$

Wₒ—weight of the dry hydrogel fiber.
Wₜ—weight of the swelled hydrogel fiber.
Water/PBS absorption of fiber described in example 1 (see FIG. 4):
Water capacity increased with temperature increase.
Water capacity was lower in the case of higher fiber radius since the ratio of the surface exposed to the water to the volume was smaller.

The calculated water uptake of each of the hydrogel fiber compositions of the invention is shown in table 1 above.

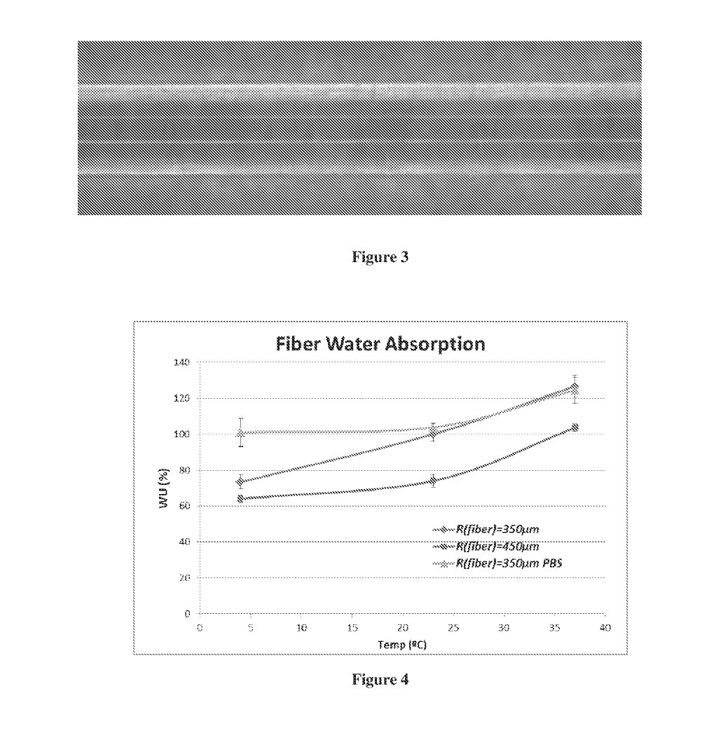

An optical microscope image of the fiber obtained from composition of Exp. No. 1 at room temperature after swelling is shown at FIG. 3.

### Optical Properties:

Optical attenuation for tested hydrogels (Table 1) was between 300 and 5000 dB/km. Fibers with water uptake (swelling) of above 250% were too fragile to measure their optical attenuation.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A polymer fiber wherein said polymer is an aqueous-solution absorbing polymer.

2. The fiber of claim 1, wherein said polymer fiber is a polymer optical fiber.

3. The fiber of claim 1, wherein said fiber is crosslinked less than about 4% mole crosslinking density.

4. The fiber of claim 1, wherein said aqueous-solution absorbing polymer has a water uptake of up to 2000% w/w.

5. The fiber of claim 2, wherein said aqueous-solution absorbing polymer has a water uptake of up to 250% w/w.

6. The polymer fiber of claim 1, wherein said polymer is a thermoset polymer.

7. The polymer fiber of claim 1, further encapsulating an active material, wherein said active material comprises an agrochemical material, a fluorescent probe, flavoring material, soothing material, a pharmaceutical or any combination thereof.

8. The polymer fiber of claim 1, wherein said aqueous solution is water.

9. The polymer fiber of claim 1, wherein said polymer comprises 2-hydroxyethyl acrylamide (HEAAm), acrylic acid or salt thereof, or any combination thereof.

10. A method of preparing an aqueous solution-absorbing polymer fiber comprising the following steps:
(i) providing a monomeric or oligomeric mixture, wherein said monomeric or oligomeric mixture comprise hydrophilic monomers or oligomers, which polymerize by radiation;
(ii) optional heating or cooling said monomeric or oligomeric mixture, for obtaining optimal viscosity;
(iii) continuously pumping said monomeric or oligomeric mixture through a spinneret die or any other nozzle arrangement; and
(iv) continuously radiating said monomeric or oligomeric mixture with a radiation source, wherein said aqueous solution-absorbing polymer fiber is formed.

11. The method of claim 10, wherein said polymer is an aqueous solution-absorbing polymer.

12. The method according to claim 11, wherein said method is solvent free.

13. The method according to claim 11, wherein said monomeric or oligomeric mixture does not comprise charged monomers or oligomers.

14. The method according to claim 10, wherein said monomeric or oligomeric mixture comprises charged monomers or oligomers.

15. The method according to claim 10, wherein said method further comprises a step of adding small amount of solvent after step (i).

16. (canceled)

17. The method according to claim 15, wherein said solvent is water at an amount of up to 20% w/w of the mixture or said solvent is at an amount of up to 5% w/w of the mixture.

18. (canceled)

19. The method according to claim 15, wherein said polymer fiber is a polymer optical fiber (POF).

20. The method according to claim 10, wherein said aqueous-solution absorbing polymer has a water uptake of up to 1000% w/w.

21. The method according to claim 10, wherein said aqueous-solution absorbing polymer has a water uptake of up to 250% w/w.

22. The method according to claim 10, wherein said polymer is a thermoset polymer.

23. The method according to claim 10, wherein said monomeric or oligomeric mixture comprises acrylate, methacrylate, vinyl monomers or oligomers, charged monomers or oligomers or any combination thereof.

24. The method of claim 23 wherein said acrylate monomer or oligomer comprises acrylic acid or salt thereof, 2-hydroxyethyl acryl amide (HEAAm), 2-hydroxyethyl acrylate, 2-hydroxyethyl acrylate, acrylamide, 2-(2-ethoxyethoxy)ethyl acrylate, glycerol monoacrylate, or any combination thereof.

25. The method of claim 23 wherein said methacrylate monomer or oligomer comprises methacrylic acid or salt thereof, 2-hydroxyethylmethacrylate, 2-ethoxyethyl methacrylate, glycerol monomethacrylate, or any combination thereof.

26. The method according to claim 23 wherein said charged monomer or oligomer comprises sodium/potassium acrylate or methacrylates, 2-acrylamido-2-methylpropane sulfonic acid, (3-sulfopropyl)-acrylate-potassium or sodium salt, (3-sulfopropyl)-methacrylate-potassium or sodium salt, itaconicacid-bis-(3-sulfopropyl)-ester-di-potassium salt, N,N-Dimethyl-N-(2-methacryloyloxyethyl)-N-(3-sulfopropyl)ammonium betaine, N,N-Dimethyl-N-(3-methacrylamidopropyl)-N-(3-sulfopropyl)ammonium betaine, or any combination thereof.

27. The method according to claim 23 wherein said vinyl monomer comprises vinyl acetate, vinyl sulfonic acid, vinyl methylsulfone, vinyl methylacetamide, vinyl urea, 2-vinyl pyridine, 4-vinyl pyridine and vinyl-2-pyrrolidone, or any combination thereof.

28. The method according to claim 10, wherein said monomeric or oligomeric mixture comprises monofunctional monomers or oligomers, multifunctional monomers or oligomers, or combination thereof.

29. The method of claim 28, wherein said multifunctional monomers are pentaerythritoltriallyl ether, diethylene glycol divinyl ether, triethylene glycol divinyl ether, 1,1,1-trimethylolpropane diallyl ether, allyl sucrose, divinyl benzene, dipentaerythritolpentaacrylate, N,N′methylenebisacrylamide, triallylamine, triallyl citrate, ethyleneglycoldiacrylate, diethylene glycol diacrylate, di-ethylene glycol dimethacrylate, tetraethylene glycol diacrylate, trimethylol propane trimethacrylate, ethylene glycol dimethacrylate, tetraethylene glycol dimethacrylate, dipropylene glycol dimethacrylate, ditrymethylol propane tetracrylate, pentaerythritoltetraacrylate, pentaerythritoltriacrylate, polyethylene glycol diacrylate, ethoxylated trimethylolpropane triacrylate, aliphatic urethane triacrylate or any combination thereof.

30. The method according to claim 10, wherein said providing step (i) further includes a photoinitiator.

31. (canceled)

32. The method according to claim 10, wherein said monomers or oligomers are derivatized to include functional groups and form a functional polymer fiber.

33. The method of claim 32, wherein said functional groups comprise a fluorescent probe, a protein, DNA, a pharmaceutical or a combination thereof.

34. A polymer optical fiber (POF), prepared according to the method of claim 11.

35. The method according to claim 10, wherein said aqueous solution is water.
